(19) United States
(12) Patent Application Publication
(10) Pub. No.: US 2019/0086997 A1
(43) Pub. Date: Mar. 21, 2019

(54) SYSTEM AND METHOD FOR PROVIDING STIMULATION TO A USER'S SENSES

(71) Applicant: Daegu Gyeongbuk Institute of Science and Technology, Daegu (KR)

(72) Inventors: Won-Seok KANG, Daegu (KR); Sang Hun YUN, Daegu (KR)

(21) Appl. No.: 15/836,590

(22) Filed: Dec. 8, 2017

(30) Foreign Application Priority Data
Sep. 21, 2017 (KR) 10-2017-0122029

(51) Int. Cl. G06F 3/01; G06F 3/0481; G06F 3/0484

(52) U.S. Cl. CPC G06F 3/011; G06F 3/04847; G06F 3/04817

(57) ABSTRACT

Provided is a system and method for providing a stimulus to senses of a user. A stimulus providing method may include generating components associated with a protocol; providing components selected by a user from among the components on a component arrangement area; defining a parent relationship or a child relationship by connecting the components provided on the component arrangement area based on a type of each of the components provided on the component arrangement area; determining attributes of components of which the parent relationship or the child relationship is defined; and controlling a stimulus providing device to sequentially provide a stimulus to senses of the user based on a connection relationship between the components and the attributes of the components.

### BACKGROUND

### Field

One or more example embodiments relate to a system and method for providing a stimulus to senses of a user.

### Description of Related Art

Techniques that provide a stimulus to senses of a user, for example, a visual sense, a haptic sense, a gustatory sense, an olfactory sense, and an auditory sense, are being developed. For example, technology for providing a haptic stimulus to a user or an odor output device for displaying an olfactory stimulus for the user is disclosed in Korea Patent Application No. 10-2014-0048079.

However, in the case of performing an experiment of providing a stimulus for visual, haptic, gustatory, olfactory, and auditory senses to a user and verifying a user reaction to the stimulus, a protocol for controlling the stimulus provided to the user needs to be coded to precisely provide the stimulus for visual, haptic, gustatory, olfactory, and auditory senses to the user. Accordingly, a coding process may increase cost and an experiment period.

Accordingly, there is a need for a method that may control a stimulus to be provided to another user or a corresponding user through a stimulus providing device without using a coding process.

### SUMMARY

At least one example embodiment provides a system and method that enables a user to easily control a stimulus to be provided to the user or another user using a stimulus providing device by connecting components associated with a protocol for providing a stimulus and by editing a stimulus providing order, a stimulus type, and a stimulus providing time for each sense.

According to an aspect of at least one example embodiment, there is provided a method of providing a stimulus to senses of a user, the method including generating components associated with a protocol; providing components selected by a user from among the components on a component arrangement area; defining a parent relationship or a child relationship by connecting the components provided on the component arrangement area based on a type of each of the components provided on the component arrangement area; determining attributes of components of which the parent relationship or the child relationship is defined; and controlling a stimulus providing device to sequentially provide a stimulus to the senses of the user based on a connection relationship between the components and the attributes of the components.

A type of each of the components associated with the protocol may be one of a protocol component for representing the protocol, a complex component for representing a group of a plurality of components, a base component for representing a minimum unit of the protocol, and an action component for controlling a device configured to provide a stimulus to the senses of the user.

The protocol component may include a structure for connecting at least one complex component as a child relationship of the protocol component.

The complex component may include a structure for connecting the protocol component as a parent relationship of the complex component and a structure for connecting another complex component or the base component as a child relationship of the complex component.

The base component may include a structure for connecting the protocol component or the complex component as a parent relationship of the base component and a structure for connecting the action component as a child relationship of the base component.

The action component may include a structure for connecting the base component as a parent relationship of the action component and is one of types providing a stimulus to each of five senses of the user and a type indicating a state in which the stimulus to the senses of the user is absent.

According to an aspect of at least one example embodiment, there is provided a method of providing a stimulus to senses of a user, the method including providing a control component associated with control of a protocol among components associated with the protocol on a component arrangement area; connecting, to the control component, stimulus components each providing a stimulus to each of five senses of the user or an idle component indicating that the stimulus to the senses of the user is absent, among the components associated with the protocol; connecting at least one information component for representing information to the control component, the stimulus components, and the idle component; and controlling a stimulus providing device to sequentially provide the stimulus to the senses of the user based on the information component and a connection relationship between the components.

The information component may include at least one of a device information component that includes stimulus providing device information for providing the stimulus to the senses of the user, a software information component that includes software information for providing the stimulus to the senses of the user, a stimulus information component that includes stimulus information for providing the stimulus to the senses of the user, a path information component that includes a path of the stimulus information, and a time information component that includes operation time information.

The control component, the stimulus components, and the idle component may include a structure for connecting to another control component, another stimulus component, and another idle component based on a horizontal relationship, respectively.

According to an aspect of at least one example embodiment, there is provided a system for providing a stimulus to senses of a user, the system including a stimulus editing device configured to generate components associated with a protocol, to provide components selected by a user from among the components on a component arrangement area, to define a parent relationship or a child relationship by connecting the components provided on the component arrangement area based on a type of each of the components provided on the component arrangement area, to determine attributes of components of which the parent relationship or the child relationship is defined, and to control a stimulus providing device to sequentially provide a stimulus to the senses of the user based on a connection relationship between the components and the attributes of the components; and the stimulus providing device configured to sequentially provide the stimulus to the senses of the user under control of the stimulus editing device.

According to example embodiments, a user may easily control a stimulus to be provided to the user or another user using a stimulus providing device by connecting components associated with a protocol for providing a stimulus and by editing a stimulus providing order, a stimulus type, and a stimulus providing time for each sense.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a system for providing a stimulus to senses of a user according to an example embodiment;

FIG. 2 illustrates an example of an editing screen and a component provided by a stimulus editing device according to an example embodiment;

FIG. 3 illustrates an example of a process of connecting components according to the example embodiment;

FIG. 4 illustrates an example of an attribute determining process according to the example embodiment;

FIG. 5 illustrates an example of an editing screen provided by a stimulus editing device according to another example embodiment;

FIG. 6 illustrates an example of a control component according to the other example embodiment;

FIG. 7 illustrates an example of an idle component according to the other example embodiment;

FIG. 8 illustrates an example of a visual stimulus component according to the other example embodiment;

FIG. 9 illustrates an example of an auditory stimulus component according to the other example embodiment;

FIG. 10 illustrates an example of an olfactory stimulus component according to the other example embodiment;

FIG. 11 illustrates an example of a gustatory stimulus component according to the other example embodiment;

FIG. 12 illustrates an example of a haptic stimulus component according to the other example embodiment;

FIG. 13 illustrates an example of a connection structure included in components according to the other example embodiment;

FIGS. 14 and 15 illustrate an example of a process of connecting components according to the other example embodiment;

FIG. 16 is a flowchart illustrating a method of providing a stimulus to senses of a user according to the example embodiment; and

FIG. 17 is a flowchart illustrating a method of providing a stimulus to senses of a user according to the other example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Herein, a method (also, referred to as a stimulus providing method) of providing a stimulus to senses of a user according to an example embodiment may be performed by a system (also, referred to as a stimulus providing system) for providing a stimulus to senses of a user according to an example embodiment.

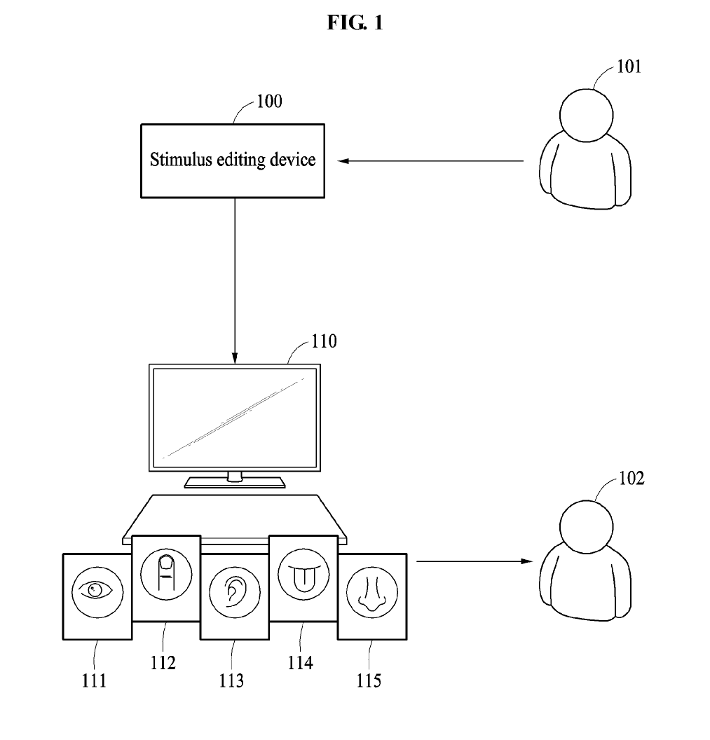

FIG. 1 is a diagram illustrating a system for providing a stimulus to senses of a user according to an example embodiment.

Referring to FIG. 1, the stimulus providing system may include a stimulus editing device 100 and a stimulus providing device 110.

The stimulus editing device 100 may edit a stimulus for each sense to be provided to a user 102 in response to a user from a user 101. Here, the user 101 that edits the stimulus may be the same as or may be different from the user 102 that receives the stimulus.

In detail, the stimulus editing device 100 may connect components associated with a protocol for providing the stimulus and may edit a stimulus providing order, a stimulus type, and a stimulus providing time for each sense. The stimulus editing device 100 may instruct the stimulus providing device 110 to sequentially provide a stimulus to senses of the user 102 based on an edition result.

Here, the stimulus editing device 100 may be a terminal including an input device for the user 101 to select a component and a communication device configured to instruct the stimulus providing device 110 to sequentially provide the stimulus to the senses of the user 102. For example, the stimulus editing device 100 may be one of a personal computer (PC), a tablet, and a mobile device.

The stimulus editing device 100 may include a function of storing a graphics user interface (GUI) protocol configured by the user 101 or the user 102 in a form of a mark-up language (XML) and loading the GUI protocol.

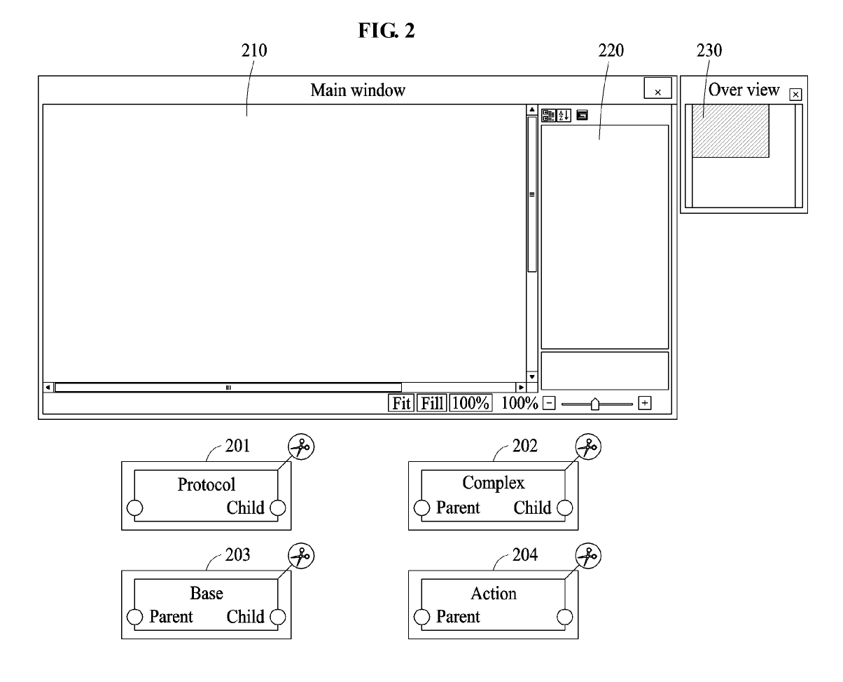

Hereinafter, an operation of the stimulus editing device 100 is described with reference to FIGS. 2 through 17.

In response to an instruction of the stimulus editing device 100, the stimulus providing device 110 may provide the stimulus to the senses of the user 102. Although FIG. 1 illustrates the stimulus providing device 110 as a PC, it is provided as an example only. The stimulus providing device 110 may be configured as hardware based on a type of a stimulus to be provided to the user 102.

For example, the stimulus providing device 110 for a visual sense 111 may include a display configured to display a visual stimulus for the user 102. Also, the stimulus providing device 110 for a haptic sense 112 may include at least one of vibrating or electrical devices configured to provide a haptic stimulus to the user 102. For example, the stimulus providing device 110 for the haptic sense 112 may be a device to which haptics technology is applied or a haptic glove.

The stimulus providing device 110 for an auditory sense 113 may include a speaker or an earphone configured to output an auditory stimulus to the user 102. Also, the stimulus providing device 110 for a gustatory sense 114 may include an injection device configured to provide a gustatory stimulus to the user 102 in the mouth of the user 102. For example, the stimulus providing device 110 for the gustatory sense 114 may include an injection port configured to inject a gustatory solution or a cleaning solution for cleaning the inside mouth of the user 102 into the mount of the user 102, a sucker configured to remove the injected solution, and a controller configured to control an injection amount of the gustatory solution and a component included in the gustatory solution.

The stimulus providing device 110 for an olfactory sense 115 may include an odor output device configured to display an olfactory stimulus for the user 102. For example, the stimulus providing device 110 for the olfactory sense 115 may include an olfactory stimulus supplier provided to a noise of the user 102 and a controller configured to control a type of an olfactory stimulus to be generated, a time for supplying the olfactory stimulus, and a time for maintain the olfactory stimulus.

According to an example embodiment, the stimulus providing system enables a user to easily control a stimulus to be provided to the user or another user using a stimulus providing device by connecting components associated with a protocol for providing a stimulus and by editing a stimulus providing order, a stimulus type, and a stimulus providing time for each sense.

FIG. 2 illustrates an example of an editing screen and a component provided by a stimulus editing device according to an example embodiment.

Referring to FIG. 2, the editing screen provided by the stimulus editing device may include a component arrangement area 210, a component attribute area 220, and an overview window 230.

The component arrangement area 210 may be an area for providing components associated with a stimulus providing protocol and defining a relationship between the components.

The component attribute area 220 may be an area for displaying an attribute of a component selected by a user from among the components provided on the component arrangement area 210. Also, the attribute of the component displayed on the component attribute area 220 may be changed in response to an input of the user and the changed attribute may be stored as the attribute of the corresponding component.

The overview window 230 may display a relationship between all of the components provided on the component arrangement area 210 by reducing and thereby displaying the components provided on the component arrangement area 210.

That is, the overview window 230 may be activated when it is possible to provide components on a wider area than an area displayed on the component arrangement area 210. The overview window 230 may distinguishably display a screen currently displayed on the component arrangement area 210 to be a hatched area of FIG. 2, and may notify the user of which portion the screen currently displayed on the component arrangement area 210 indicates in the relationship between all of the components.

Referring to FIG. 2, the stimulus editing device may generate at least one of a protocol component 201, a complex component 202, a base component 203, and an action component 204.

The protocol component 201 may be a component for representing a stimulus providing protocol and may be a component that is provided most initially among components. That is, since no component is connected as a parent relationship of the protocol component 201, the protocol component 201 may not include a structure to be connected as a parent relationship with another component. The protocol component 201 may include a structure for connecting at least one complex component 202 as a child relationship of the protocol component 201.

Once protocols are provided and connected and then, attributes of the components are determined, the protocol component 201 may automatically proceed with a protocol specification.

The complex component 202 may be a lower component of the protocol component 201 and may be a component for representing a group of components that include a plurality of base components 203. Here, the complex component 202 may include a structure for connecting the protocol component 201 as a parent relationship of the complex component 202 and a structure for connecting another complex component or the base component 203 as a child relationship of the complex component 202.

The base component 203 may be a component for representing a minimum unit of the protocol. Here, the base component 203 may include a structure for connecting the protocol component 201 or the complex component 202 as a parent relationship of the base component 203 and a structure for connecting the action component 204 as a child relationship of the base component 203.

The action component 204 may be a component for controlling a device configured to provide a stimulus to senses of the user. Here, the action component 204 may include a structure for connecting the base component 203 as a parent relationship of the action component 204. The action component 204 is a bottom component among the components and thus, may not include a structure for connection as a child relationship with another component.

Also, the action component 204 may be one of types providing a stimulus to each of the five senses of the user and a type indicating that the stimulus to the senses of the user is absent. For example, the action component 204 may be one of an Action Visual component (visual component) configured to provide a visual stimulus, an Action Haptic component (haptic component) configured to provide a haptic stimulus, an Action Auditory component (auditory component) configured to provide an auditory stimulus, an Action Gustatory component (gustatory component) configured to provide a gustatory stimulus, an Action Olfactory component (olfactory component) configured to provide an olfactory stimulus, and a none-component configured to indicate that no stimulus is present.

Also, an initial value of the action component 204 may be the none-component indicating that no stimulus is present. During a process of determining an attribute of the action component 204, the stimulus editing device may change the none-component with one of the visual component, the haptic component, the auditory component, the gustatory component, and the olfactory component.

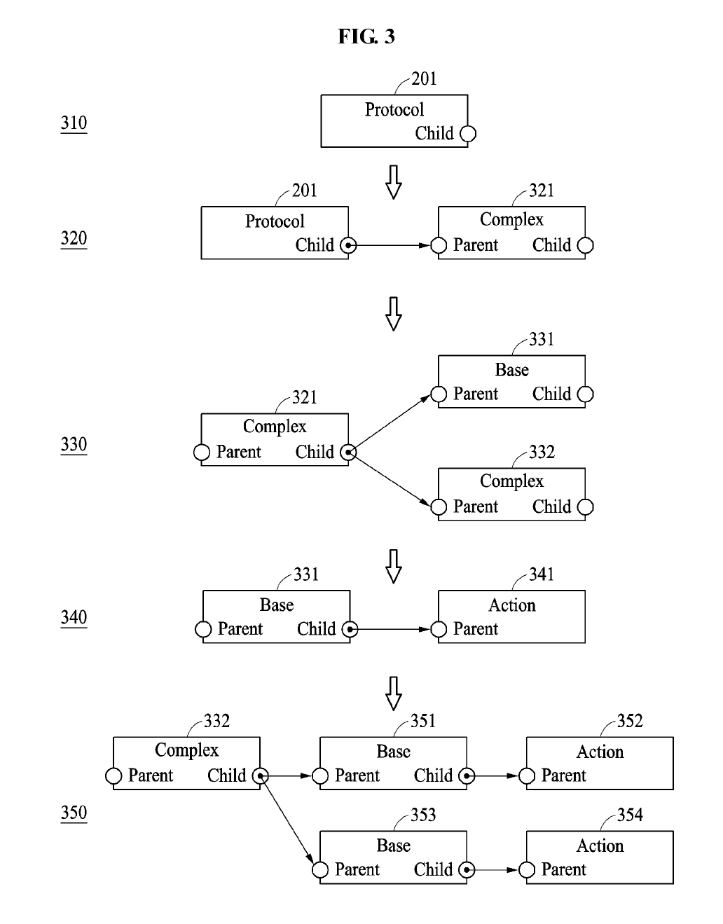

FIG. 3 illustrates an example of a process of connecting components according to the example embodiment to perform a stimulus control protocol as shown in Table 1.

Referring to FIG. 3, in operation 310, a stimulus editing device may provide the protocol component 201 on the component arrangement area 210.

In operation 320, the stimulus editing device may additionally provide a first complex call component 321 on the component arrangement area 210. The stimulus editing device may provide and connect the first complex call component 321 to the protocol component 201 provided in operation 310 as a child relationship thereof.

In operation 330, the stimulus editing device may additionally provide a first base component 331 and a second complex call component 332 on the component arrangement area 210. Here, the stimulus editing device may provide and connect the first base component 331 and the second complex call component 332 to the first complex call component 321 provided in operation 320 as a child relationship thereof.

In operation 340, the stimulus editing device may additionally provide a first action component 341 on the component arrangement area 210. The stimulus editing device may provide and connect the first action component 341 to the first base component 331 provided in operation 330 as a child relationship thereof.

In operation 350, the stimulus editing device may additionally provide a second base component 351 and a third base component 353 on the component arrangement area 210. Here, the stimulus editing device may provide and connect the second base component 351 and the third base component 353 to the second complex call component 332 provided in operation 330 as a child relationship thereof.

The stimulus editing device may additionally provide a second action component 352 and a third action component 354 on the component arrangement area 210. Here, the stimulus editing device may provide and connect the second action component 352 and the third action component 354 to the second base component 351 and the third base component 353 as a child relationship thereof, respectively.

If the stimulus editing device controls the stimulus providing device 110 in the component connection state of FIG. 3, the stimulus editing device may initially control the stimulus providing device 110 corresponding to an attribute of the first action component 341 closest to the protocol component 201 among action components. The stimulus editing device may sequentially control the stimulus providing device 110 corresponding to an attribute of the second action component 352 and the stimulus providing device 110 corresponding to an attribute of the third action component 354.

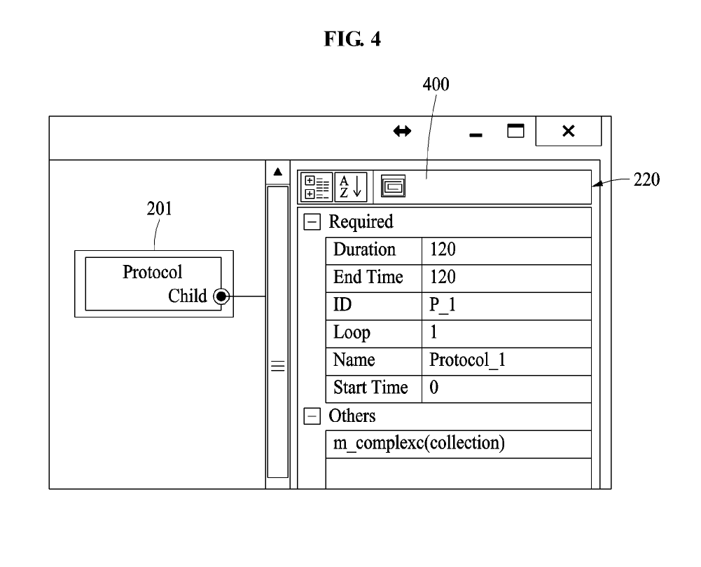

FIG. 4 illustrates an example of an attribute determining process according to the example embodiment.

Referring to FIG. 4, if a user selects a component in the component connection state of FIG. 3, the stimulus editing device may display an attribute 400 of the selected component on the component attribute area 220.

The attribute of the protocol component 201 may include a duration of a protocol, an end time of the protocol, identification (ID) information of the protocol, a loop of the protocol, a name of the protocol, and a start time of the protocol.

A value of the attribute 400 of the component displayed on the component attribute area 220 may be changed in response to an input of the user.

For example, in a none-component state, none stimulus providing device (Device) may correspond to an attribute of the action component 204. If a value of the stimulus providing device (Device) is changed from none to display, the stimulus editing device may change a type of the action component 204 from a none-component to a visual component. Also, if a value of the stimulus providing device (Device) is changed from none to a speaker, the stimulus editing device may change the type of the action component 204 from the none-component to an auditory component.

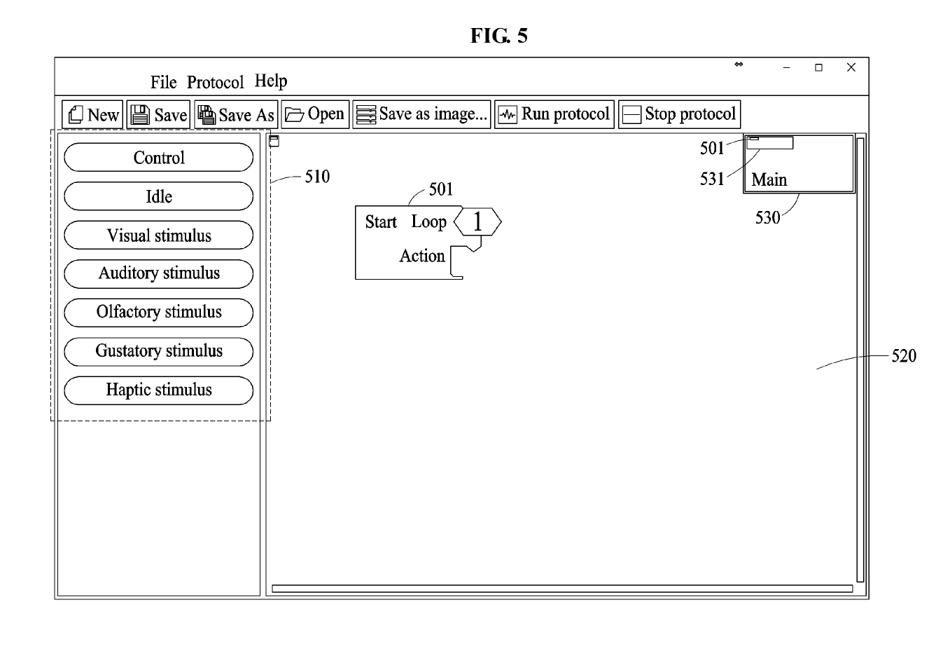

FIG. 5 illustrates an example of an editing screen provided from a stimulus editing device according to another example embodiment.

According to the other example embodiment, the stimulus editing device may generate, as an information component that is a bottom level component, each piece of information set based on an attribute of a component according to the example embodiment and may replace the aforementioned attribute determining process with a process of connecting an information component having a corresponding attribute value.

Referring to FIG. 5, the editing screen provided by the stimulus editing device may include a component group area 510, a component arrangement area 520, and an overview window 530.

The component group area 510 may be an area for grouping and displaying components associated with a stimulus providing protocol for each function.

The component arrangement area 520 may be an area for providing components, for example, a component 501, selected by a user from among the components displayed on the component group area 510 and connecting the provided components.

The overview window 530 may display a relationship between all of the components provided on the component arrangement area 520 by reducing and thereby displaying the components displayed on the component arrangement area 520. That is, the overview window 530 may be activated when it is possible to provide components on a wider area than an area displayed on the component arrangement area 210. The overview window 530 may notify the user of which portion the screen currently displayed on the component arrangement area 520 indicates in the relationship between all of the components by indicating a screen currently displayed on the component arrangement area 520 using an outline 531.

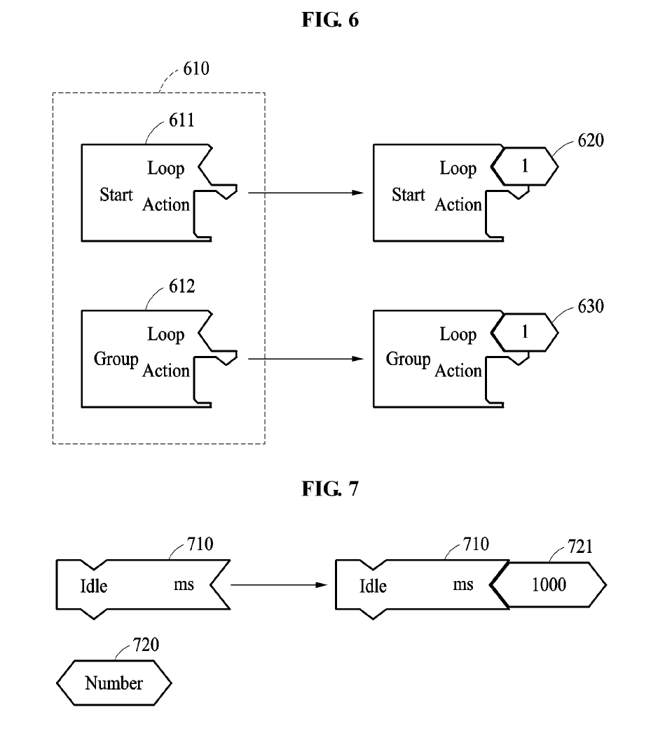

FIG. 6 illustrates an example of a control component according to the other example embodiment.

Referring to FIG. 6, a control component group 610 among component groups displayed on the component group area 510 may include a start component 611 and a group component 612.

The start component 611 may be a component corresponding to the protocol component 201 according to the example embodiment and may be a component that defines a start of a stimulus providing protocol.

Accordingly, similar to the protocol component 201, an upper component may not be connected to the start component 611.

Also, at least one of a group component, an idle component, a visual stimulus component, an auditory stimulus component, an olfactory stimulus component, a gustatory stimulus component, and a haptic stimulus component may be connected as a lower component of the start component 611. The start component 611 may have no neighbor component that is connected as a horizontal relationship.

An information component connected to the start component 611 may be a number component 620 indicating a loop of the protocol.

The group component 612 may be a component corresponding to the aforementioned complex component 202 and may be a component for designating a group that includes a plurality of components.

Here, the start component 611 or another group component may be connected as an upper component of the group component 612. Also, at least one of another group component, the idle component, the visual stimulus component, the auditory stimulus component, the olfactory stimulus component, the gustatory stimulus component, and the haptic stimulus component may be connected as a lower component of the group component 612. The other group component, the idle component, the visual stimulus component, the auditory stimulus component, the olfactory stimulus component, the gustatory stimulus component, and/or the haptic stimulus component may be connected as a neighbor component of the group component 612.

An information component connected to the group component 612 may be a number component 630 indicating a loop of each of components included in the group component 612.

FIG. 7 illustrates an example of an idle component according to the other example embodiment.

An idle component group among component groups displayed on the component group area 510 may be a group of idle components 710 corresponding to a none-component indicating a stimulus absence state in the action component 204 according to the example embodiment. In detail, the idle component 710 may be a component in which the base component 203 and the none-component according to the example embodiment are combined.

Here, the start component 611 or the group component 612 may be connected as an upper component of the idle component 710. Since the idle component 710 is a bottom level component, a lower component may not be connected to the idle component 710.

At least one of a group component, another idle component, a visual stimulus component, an auditory stimulus component, an olfactory stimulus component, a gustatory stimulus component, and a haptic stimulus component may be connected as a neighbor component of the idle component 710.

At least one of a group component and another idle component may be connected as a neighbor component of the idle component 710.

An information component connected to the idle component 710 may be a number component 720 indicating an operation time of the idle component 710. For example, a number component 721 that allows the idle component 710 to operate during 1000 milliseconds may be connected to the idle component 710.

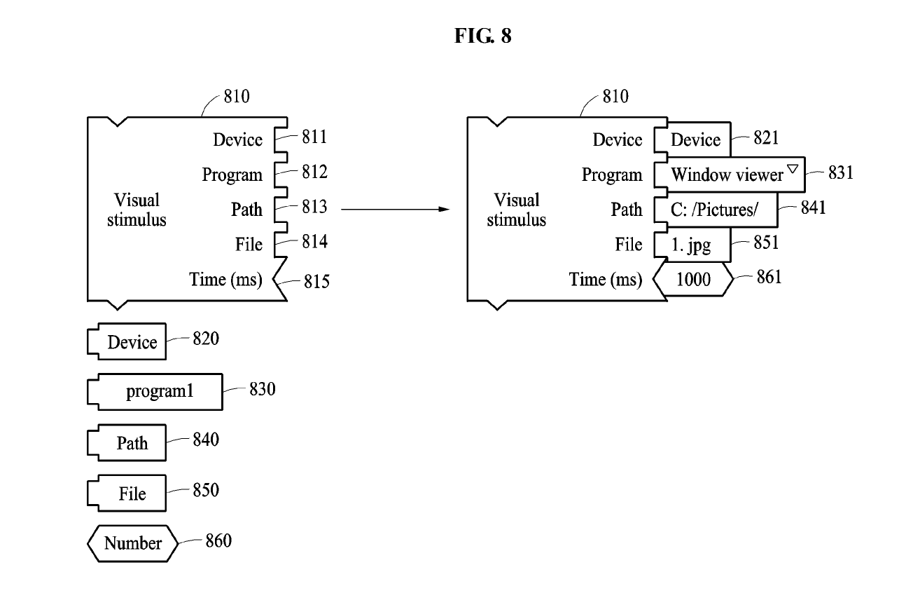

FIG. 8 illustrates an example of a visual stimulus component according to the other example embodiment.

A visual stimulus component group among component groups displayed on the component group area 510 may be a group of visual stimulus components 810 corresponding to the Action Visual component (visual component) in the action component 204 according to the example embodiment. In detail, the visual stimulus component 810 may be a component in which the base component 203 and the Action Visual component according to the example embodiment are combined.

Here, the start component 611 or the group component 612 may be connected as an upper component of the visual stimulus component 810. Since the visual stimulus component 810 is a bottom level component, a lower component may not be connected to the visual stimulus component 810.

At least one of a group component, an idle component, another visual stimulus component, an auditory stimulus component, an olfactory stimulus component, a gustatory stimulus component, and a haptic stimulus component may be connected as a neighbor component of the visual stimulus component 810.

Also, an information component connected to the visual stimulus component 810 may be a device information component 820, a software information component 830, a path information component 840, a stimulus information component 850, and a time information component 860. Here, the visual stimulus component 810 may include structures 811, 812, 813, and 814 for connecting to corresponding character string components. The device information component 820, the software information component 830, the path information component 840, and the stimulus information component 850 that are the character string components may be connected to the structures 811, 812, 813, and 814, respectively. The visual stimulus component 810 may include a structure 815 for connecting to a number component, and the time information component 860 that is the number component may be connected to the structure 815.

The device information component 820 may be a character string component that represents ID information of the stimulus providing device 110 providing a visual stimulus, using a character string. For example, the device information component 820 may be a component 821 that indicates a name of the stimulus providing device 110 providing the visual stimulus.

The software information component 830 may be a character string component that represents ID information of software for providing the visual stimulus, using a character string. For example, the software information component 830 may be a component 831 that indicates a name of a viewer for providing the visual stimulus.

The path information component 840 may be a character string component that represents storage location information associated with a resource for providing the visual stimulus, using a character string. For example, the path information component 840 may be a component 841 that indicates a path for moving to a location at which an image file for providing the visual stimulus is stored.

The stimulus information component 850 may be a character string component that represents a name of stimulus information, i.e., a resource for providing the visual stimulus among resources stored at the location indicated by the path information component 840, using a character string. For example, the stimulus information component 850 may be a component 851 that indicates an image file name for providing the visual stimulus.

The time information component 860 may be a number component for indicating an operation time of the visual stimulus component 810. For example, the time information component 860 may be a component 861 that indicates a number allowing the visual stimulus component 810 to operate during 1000 milliseconds (ms).

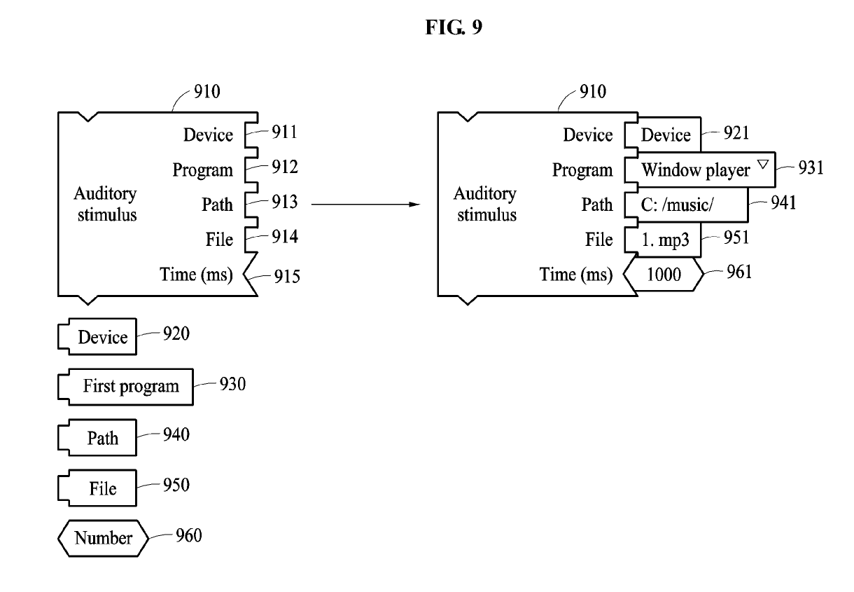

FIG. 9 illustrates an example of an auditory stimulus component according to the other example embodiment.

An auditory stimulus component group among component groups displayed on the component group area 510 may be a group of auditory stimulus components 910 corresponding to the Action Auditory component (auditory component) in the action component 204 according to the example embodiment. In detail, the auditory stimulus component 910 may be a component in which the base component 203 and the Action Auditory component according to the example embodiment are combined.

Here, the start component 611 or the group component 612 may be connected as an upper component of the auditory stimulus component 910. Since the auditory stimulus component 910 is a bottom level component, a lower component may not be connected to the auditory stimulus component 910.

At least one of a group component, an idle component, a visual stimulus component, another auditory stimulus component, an olfactory stimulus component, a gustatory stimulus component, and a haptic stimulus component may be connected as a neighbor component of the auditory stimulus component 910.

Also, an information component connected to the auditory stimulus component 910 may be a device information component 920, a software information component 930, a path information component 940, a stimulus information component 950, and a time information component 960. Here, the auditory stimulus component 910 may include structures 911, 912, 913, and 914 for connecting to corresponding character string components. The device information component 920, the software information component 930, the path information component 940, and the stimulus information component 950 that are the character string components may be connected to the structures 911, 912, 913, and 914, respectively. The auditory stimulus component 910 may include a structure 915 for connecting a number component, and the time information component 960 that is the number component may be connected to the structure 915.

The device information component 920 may be a character string component that represents ID information of the stimulus providing device 110 providing an auditory stimulus, using a character string. For example, the device information component 920 may be a component 921 that indicates a name of the stimulus providing device 110 providing the auditory stimulus.

The software information component 930 may be a character string component that represents ID information of software for providing the auditory stimulus, using a character string. For example, the software information component 930 may be a component 931 that indicates a name of a player for providing the auditory stimulus.

The path information component 940 may be a character string component that represents storage location information associated with a resource for providing the auditory stimulus, using a character string. For example, the path information component 940 may be a component 941 that indicates a path for moving to a location at which an audio file for providing the auditory stimulus is stored.

The stimulus information component 950 may be a character string component that represents a name of stimulus information, i.e., a resource for providing the auditory stimulus among resources stored at the location indicated by the path information component 940, using a character string. For example, the stimulus information component 950 may be a component 951 that indicates an audio file name for providing the auditory stimulus.

The time information component 960 may be a number component for indicating an operation time of the auditory stimulus component 910. For example, the time information component 960 may be a component 961 that indicates a number allowing the auditory stimulus component 910 to operate during 1000 milliseconds (ms).

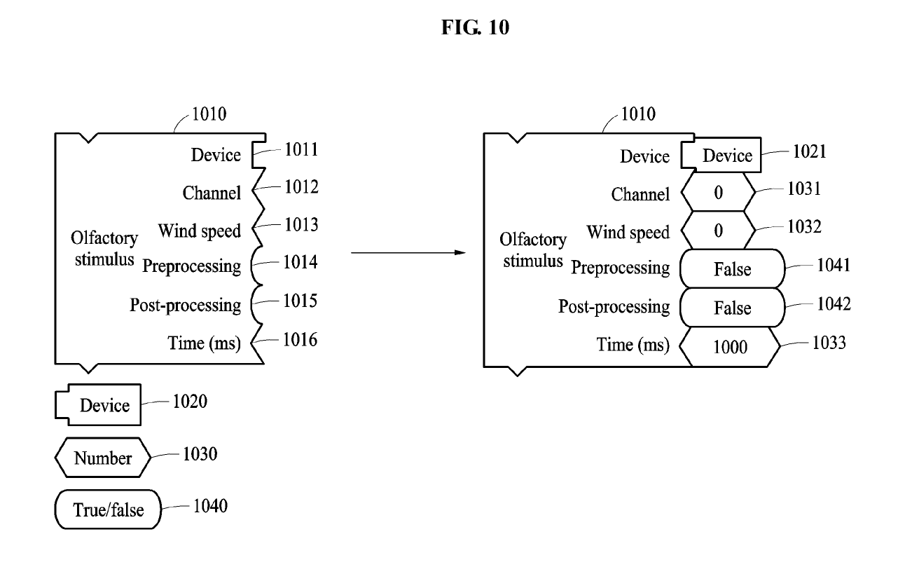

FIG. 10 illustrates an example of an olfactory stimulus component according to the other example embodiment.

An olfactory stimulus component group among component groups displayed on the component group area 510 may be a group of olfactory stimulus components 1010 corresponding to the Action Olfactory component (olfactory component) in the action component 204 according to the example embodiment. In detail, the olfactory stimulus component 1010 may be a component in which the base component 203 and the Action Olfactory component according to the example embodiment are combined.

Here, the start component 611 or the group component 612 may be connected as an upper component of the olfactory stimulus component 1010. Since the olfactory stimulus component 1010 is a bottom level component, a lower component may not be connected to the olfactory stimulus component 1010.

At least one of a group component, an idle component, a visual stimulus component, an auditory stimulus component, another olfactory stimulus component, a gustatory stimulus component, and a haptic stimulus component may be connected as a neighbor component of the olfactory stimulus component 1010.

Also, an information component connected to the olfactory stimulus component 1010 may be a character string component 1020, a number component 1030, and a true/false component 1040 indicating true or false.

Here, the olfactory stimulus component 1010 may include a structure 1011 for connecting to the character string component 1020, and a device information component 1021 that is the character string component 1020 may be connected to the structure 1011. The olfactory stimulus component 1010 may include structures 1012, 1013, and 1016 for connecting to the number component 1030. A channel information component 1031, a wind speed information component 1032, and a time information component 1033 corresponding to the number component 1030 may be connected to the structures 1012, 1013, and 1016, respectively. Also, the olfactory stimulus component 1010 may include structures 1014 and 1015 for connecting to the true/false component 1040. A preprocessing information component 1041 and a post-processing information component 1042 corresponding to the true/false component 1040 may be connected to the structures 1014 and 1015, respectively.

The device information component 1021 may be the character string component 1020 that represents ID information of the stimulus providing device 110 providing an olfactory stimulus, using a character string. For example, the device information component 1021 may be a component that indicates a name of the stimulus providing device 110 providing the olfactory stimulus.

The channel information component 1031 may be the number component 1030 that represents ID information of a channel for outputting the olfactory stimulus in the stimulus providing device 110 providing the olfactory stimulus, using a number.

The wind speed information component 1032 may be the number component 1030 that represents a speed of wind generated by the stimulus providing device 110 to transfer the olfactory stimulus to a user, using a number.

The preprocessing information component 1041 may be the true/false component 1040 that represents, as true or false, whether the stimulus providing device 110 providing the olfactory stimulus performs preprocessing prior to providing the olfactory stimulus to the user. If a value of the preprocessing information component 1041 is true, the stimulus editing device may control the stimulus providing device 110 to perform preprocessing of the olfactory stimulus prior to providing the olfactory stimulus to the user.

The post-processing information component 1042 may be the true/false component 1040 that represents, as true or false, whether the stimulus providing device 110 providing the olfactory stimulus performs post-processing after providing the olfactory stimulus to the user. If a value of the post-processing information component 1042 is true, the stimulus editing device may control the stimulus providing device 110 to perform post-processing of the olfactory stimulus after providing the olfactory stimulus to the user.

The time information component 1033 may be the number component 1030 for indicating an operation time of the olfactory stimulus component 1010. For example, the time information component 1033 may be a component that indicates a number allowing the olfactory stimulus component 1010 to operate during 5000 milliseconds (ms).

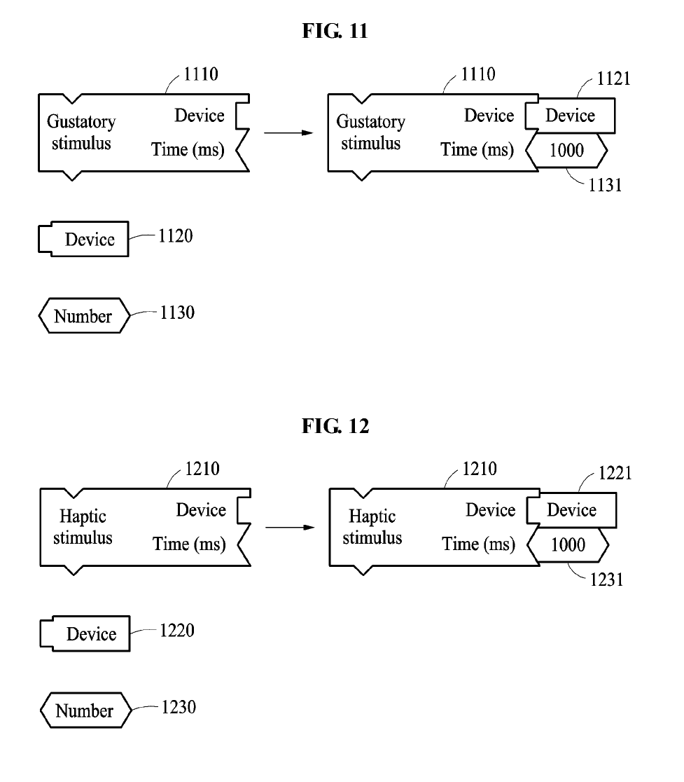

FIG. 11 illustrates an example of a gustatory stimulus component according to the other example embodiment.

A gustatory stimulus component group among component groups displayed on the component group area 510 may be a group of gustatory stimulus components 1110 corresponding to the Action Gustatory component (gustatory component) in the action component 204 according to the example embodiment. In detail, the gustatory stimulus component 1110 may be a component in which the base component 203 and the Action Gustatory component according to the example embodiment are combined.

Here, the start component 611 or the group component 612 may be connected as an upper component of the gustatory stimulus component 1110. Also, since the gustatory stimulus component 1110 is a bottom level component, a lower component may not be connected to the gustatory stimulus component 1110.

At least one of a group component, an idle component, a visual stimulus component, an auditory stimulus component, an olfactory stimulus component, another gustatory stimulus component, and a haptic stimulus component may be connected as a neighbor component of the gustatory stimulus component 1110.

Also, an information component connected to the gustatory stimulus component 1110 may be a device information component 1120 and a time information component 1130.

The device information component 1120 may be a character string component that represents ID information of the stimulus providing device 110 providing a gustatory stimulus using a character string. For example, the device information component 1120 may be a component 1121 that indicates a name of the stimulus providing device 110 providing the gustatory stimulus.

The time information component 1130 may be a number component for indicating an operation time of the gustatory stimulus component 1110. For example, the time information component 1130 may be a component 1131 that indicates a number allowing the gustatory stimulus component 1110 to operate during 1000 milliseconds (ms).

FIG. 12 illustrates an example of a haptic stimulus component among stimulus components according to the other example embodiment.

A haptic stimulus component group among component groups displayed on the component group area 510 may be a group of haptic stimulus components 1210 corresponding to the Action Haptic component (haptic component) in the action component 204 according to the example embodiment. In detail, the haptic stimulus component 1210 may be a component in which the base component 203 and the Action Haptic component (haptic component) according to the example embodiment are combined.

Here, the start component 611 or the group component 612 may be connected as an upper component of the haptic stimulus component 1210. Also, since the haptic stimulus component 1210 is a bottom level component, a lower component may not be connected to the haptic stimulus component 1210.

At least one of a group component, an idle component, a visual stimulus component, an auditory stimulus component, an olfactory stimulus component, a gustatory stimulus component, and another haptic stimulus component may be connected as a neighbor component of the haptic stimulus component 1210.

Also, an information component connected to the haptic stimulus component 1210 may be a device information component 1220 and a time information component 1230.

The device information component 1220 may be a character string component that represents ID information of the stimulus providing device 110 providing the haptic stimulus, using a character string. For example, the device information component 1220 may be a component 1221 that indicates a name of the stimulus providing device 110 providing the haptic stimulus.

The time information component 1230 may be a number component for indicating an operation time of the haptic stimulus component 1210. For example, the time information component 1230 may be a component 1231 that indicates a number allowing the haptic stimulus component 1210 to operate during 1000 milliseconds (ms).

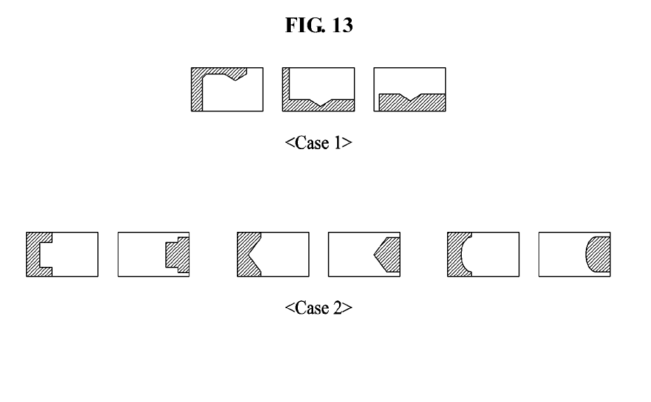

FIG. 13 illustrates an example of a connection structure included in components according to the other example embodiment.

Once components are vertically connected based on the component arrangement area 520, an expanded stimulus providing protocol may be configured by expanding a component group.

Accordingly, referring to case 1 of FIG. 13, each of the group component 612, the idle component 710, the visual stimulus component 810, the auditory stimulus component 910, the olfactory stimulus component 1010, the gustatory stimulus component 1110, and the haptic stimulus component 1210 may include a home and a block for a vertical connection based on the component arrangement area 520.

The group component 612, the idle component 710, the visual stimulus component 810, the auditory stimulus component 910, the olfactory stimulus component 1010, the gustatory stimulus component 1110, and the haptic stimulus component 1210 may be connected to another group component 612, idle component 710, visual stimulus component 810, auditory stimulus component 910, olfactory stimulus component 1010, gustatory stimulus component 1110, and haptic stimulus component 1210, respectively, using the home and the block for the vertical connection.

Also, once components are horizontally connected based on the component arrangement area 520, a component connected on the left may perform specification of information associated with a component connected on the right. Referring to case 2 of FIG. 13, components included in component groups displayed on the component group area 510 may include a home and a block for horizontal connection based on the component arrangement area 520.

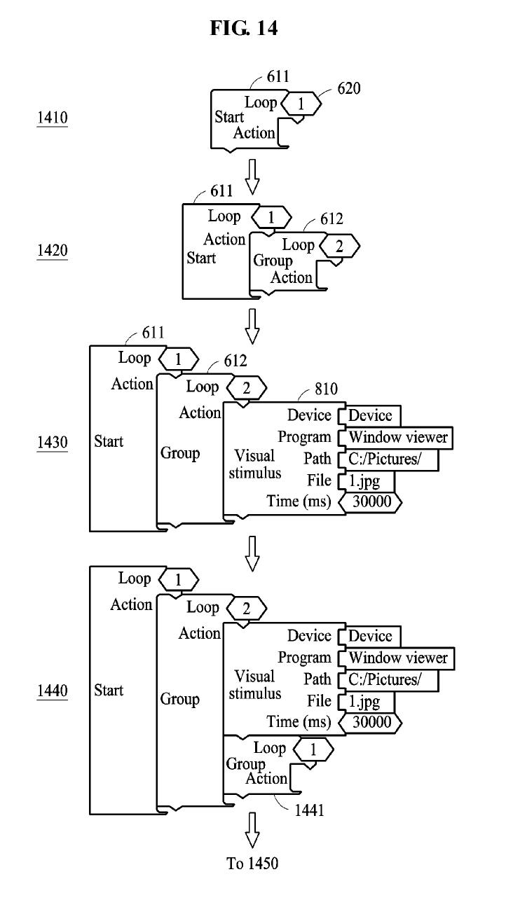

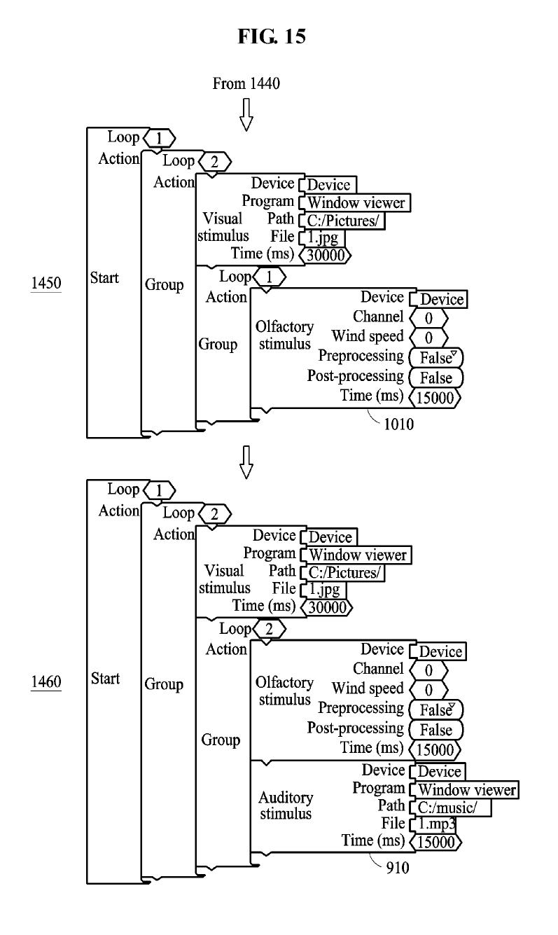

FIGS. 14 and 15 illustrate an example of a process of connecting components according to the other example embodiment to perform the stimulus control protocol shown in Table 1.

Referring to FIG. 14, in operation 1410, the stimulus editing device may provide the start component 611 on the component arrangement area 520 and may connect the number component 620 for indicating a loop of a protocol to the start component 611.

In operation 1420, the stimulus editing device may connect the group component 612 to the start component 611 provided in operation 1410. The stimulus editing device may connect the number component 630 for indicating loops of components included in the group component 612 to the group component 612.

In operation 1430, the stimulus editing device may connect the visual stimulus component 810 to the group component 612. Also, the stimulus editing device may connect, to the visual stimulus component 810, a component that indicates a name of the stimulus providing device 110 providing a visual stimulus, a component that indicates a name of a viewer for providing the visual stimulus, a component that indicates a path for moving to a location at which an image file is stored, a component that indicates an image file name, and a component that indicates a number allowing the visual stimulus component 810 to operate during 30000 milliseconds (ms).

In operation 1440, the stimulus editing device may connect a group component 1441 to the group component 612. Here, the group component 1441 may be vertically connected to the visual stimulus component 810.

In operation 1450, the stimulus editing device may connect the olfactory stimulus component 1010 to the group component 1441. Here, the stimulus editing device may connect, to the olfactory stimulus component 1010, a component that indicates a name of the stimulus providing device 110 providing an olfactory stimulus, a component that indicates ID information of a channel for outputting the olfactory stimulus, a component that indicates a speed of wind generated to transfer the olfactory stimulus to the user, a component that indicates whether the stimulus providing device 110 providing the olfactory stimulus performs preprocessing prior to providing the olfactory stimulus to the user, a component that indicates whether the stimulus providing device 110 providing the olfactory stimulus performs post-processing after providing the olfactory stimulus to the user, and a component that indicates a number allowing the olfactory stimulus component 1010 to operate during 15000 milliseconds (ms).

In operation 1460, the stimulus editing device may connect the auditory stimulus component 910 to the group component 1441. Here, the auditory stimulus component 910 may be horizontally connected to the olfactory stimulus component 1010.

Also, the stimulus editing device may connect, to the auditory stimulus component 910, a component that indicates a name of the stimulus providing device 110 providing an auditory stimulus, a component that indicates a name of a player for providing the auditory stimulus, a component that indicates a path for moving to a location at which an audio file is stored, a component that indicates an audio file name, and a component that indicates a number allowing the auditory stimulus component 910 to operate during 15000 milliseconds (ms).

Referring to FIG. 15, when the stimulus editing device controls the stimulus providing device 110 in a state in which components are connected, the stimulus editing device may control the stimulus providing device 110 providing the visual stimulus to operate during 30000 milliseconds (ms).

The stimulus editing device may control the stimulus providing device 110 providing the olfactory stimulus to operate during 15000 milliseconds (ms).

The stimulus editing device may control the stimulus providing device 110 providing the auditory stimulus to operate during 15000 milliseconds (ms).

A loop of the group component 612 corresponding to an upper level of the visual stimulus component 810, the olfactory stimulus component 1010, and the auditory stimulus component 910 is 2. Thus, the stimulus editing device may control the stimulus providing device 110 providing the visual stimulus, the stimulus providing device 110 providing the olfactory stimulus, and the stimulus providing device 110 providing the auditory stimulus to repeat the aforementioned operation.

That is, referring to FIGS. 14 and 15, the stimulus editing device according to the other example embodiment may define detailed specification by horizontally connecting the components and may configure an expanded stimulus providing protocol by vertically connecting and expanding the components.

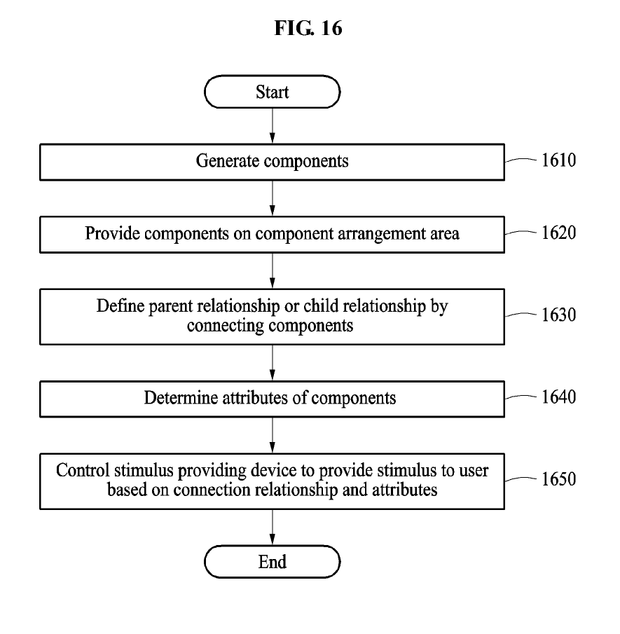

FIG. 16 is a flowchart illustrating a method of providing a stimulus to senses of a user according to the example embodiment.

Referring to FIG. 16, in operation 1610, the stimulus editing device may generate components associated with a stimulus providing protocol.

In operation 1620, the stimulus editing device may provide components selected by a user from among the components generated in operation 1610 on a component arrangement area.

In operation 1630, the stimulus editing device may define a parent relationship or a child relationship by connecting the components provided on the component arrangement area based on a type of each of the components provided on the component arrangement area in operation 1620.

In operation 1640, the stimulus editing device may determine attributes of components of which the parent relationship or the child relationship is defined. Here, the stimulus editing device may determine the attributes of the components by editing or correcting initial values of attributes of the components.

In operation 1650, the stimulus editing device may control the stimulus providing device to sequentially provide a stimulus to the senses of the user based on a connection relationship between the components and the determined attributes of the components.

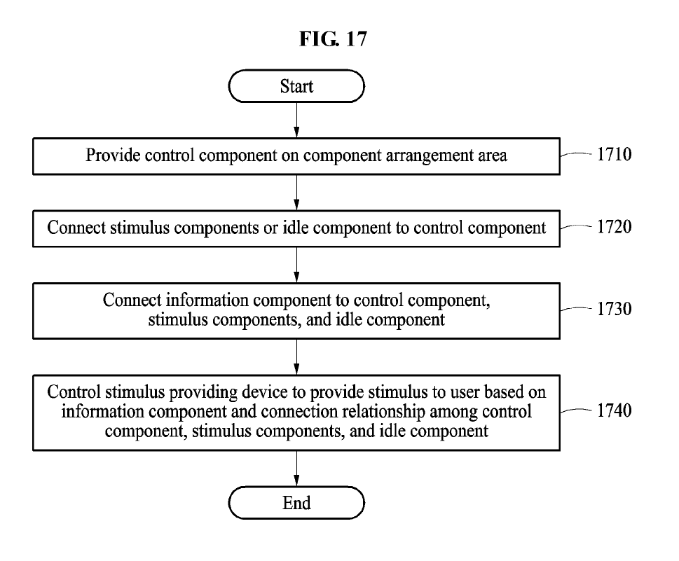

FIG. 17 is a flowchart illustrating a method of providing a stimulus to senses of a user according to the other example embodiment.

In operation 1710, the stimulus editing device may provide a control component associated with control of a protocol among components associated with a stimulus providing protocol on a component arrangement area.

In operation 1720, the stimulus editing device may connect, to the control component provided in operation 1710, stimulus components each providing a stimulus to each of five senses of the user or an idle component indicating the stimulus to the senses of the user is absent, among the components associated with the stimulus providing protocol.

In operation 1730, the stimulus editing device may connect at least one information component for representing information to the control component provided in operation 1710, the stimulus components, and the idle component provided in operation 1720.

In operation 1740, the stimulus editing device may control the stimulus providing device to sequentially provide a stimulus to the senses of the user based on a connection relationship between the components and the information component connected in operation 1730.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing a stimulus to senses of a user, the method comprising:
generating components associated with a protocol;
providing components selected by a user from among the components on a component arrangement area;
defining a parent relationship or a child relationship by connecting the components provided on the component arrangement area based on a type of each of the components provided on the component arrangement area;
determining attributes of components of which the parent relationship or the child relationship is defined; and
controlling a stimulus providing device to sequentially provide a stimulus to the senses of the user based on a connection relationship between the components and the attributes of the components.

2. The method of claim 1, wherein a type of each of the components associated with the protocol is one of a protocol component for representing the protocol, a complex component for representing a group of a plurality of components, a base component for representing a minimum unit of the protocol, and an action component for controlling a device configured to provide a stimulus to the senses of the user.

3. The method of claim 2, wherein the protocol component includes a structure for connecting at least one complex component as a child relationship of the protocol component.

4. The method of claim 2, wherein the complex component includes a structure for connecting the protocol component as a parent relationship of the complex component and a structure for connecting another complex component or the base component as a child relationship of the complex component.

5. The method of claim 2, wherein the base component includes a structure for connecting the protocol component or the complex component as a parent relationship of the base component and a structure for connecting the action component as a child relationship of the base component.

6. The method of claim 2, wherein the action component includes a structure for connecting the base component as a parent relationship of the action component and is one of types providing a stimulus to each of five senses of the user and a type indicating a state in which the stimulus to the senses of the user is absent.

7. A method of providing a stimulus to senses of a user, the method comprising:
providing a control component associated with control of a protocol among components associated with the protocol on a component arrangement area;
connecting, to the control component, stimulus components each providing a stimulus to each of five senses of the user or an idle component indicating that the stimulus to the senses of the user is absent, among the components associated with the protocol;
connecting at least one information component for representing information to the control component, the stimulus components, and the idle component; and
controlling a stimulus providing device to sequentially provide the stimulus to the senses of the user based on the information component and a connection relationship between the components.

8. The method of claim 7, wherein the information component comprises at least one of a device information component that includes stimulus providing device information for providing the stimulus to the senses of the user, a software information component that includes software information for providing the stimulus to the senses of the user, a stimulus information component that includes stimulus information for providing the stimulus to the senses of the user, a path information component that includes a path of the stimulus information, and a time information component that includes operation time information.

9. The method of claim 7, wherein the control component, the stimulus components, and the idle component include a structure for connecting to another control component, another stimulus component, and another idle component based on a horizontal relationship, respectively.

10. A system for providing a stimulus to senses of a user, the system comprising:
a stimulus editing device configured to generate components associated with a protocol, to provide components selected by a user from among the components on a component arrangement area, to define a parent relationship or a child relationship by connecting the components provided on the component arrangement area based on a type of each of the components provided on the component arrangement area, to determine attributes of components of which the parent relationship or the child relationship is defined, and to control a stimulus providing device to sequentially provide a stimulus to the senses of the user based on a connection relationship between the components and the attributes of the components; and
the stimulus providing device configured to sequentially provide the stimulus to the senses of the user under control of the stimulus editing device.
